(19) United States
(12) Patent Application Publication
(10) Pub. No.: US 2017/0155569 A1
(43) Pub. Date: Jun. 1, 2017

(54) TEST CASE BASED VIRTUAL MACHINE (VM) TEMPLATE GENERATION

(71) Applicant: Telefonaktiebolaget LM Ericsson (publ), Stockholm (SE)

(72) Inventors: Sudhagar CHINNASWAMY, Coimbatore (IN); Tsang Ming JIANG, Fremont, CA (US)

(21) Appl. No.: 14/954,973

(22) Filed: Nov. 30, 2015

(51) Int. Cl. H04L 12/26; H04L 29/08; H04L 12/24

(52) U.S. Cl. CPC H04L 43/50; H04L 41/12; H04L 67/10

(57) ABSTRACT

A method is implemented by a computing device to automatically generate a virtual machine (VM) template to be used by a test orchestrator for creating a virtualized testing environment in which to perform a networking test. The method includes obtaining a test script from a test script repository, parsing the test script to determine a set of network devices involved in the networking test and a network connectivity among the set of network devices, and generating the VM template based on the set of network devices involved in the networking test and the network connectivity among the set of network devices, where the VM template defines a configuration of networked VMs that virtualizes the set of network devices involved in the networking test and the network connectivity among the set of network devices. A test orchestrator can administer creation of the virtualized testing environment based on the VM template.

### FIELD

Embodiments of the invention relate to the field of network testing, and more specifically, to the automatic generation of virtual machine (VM) templates that can be used to create virtualized testing environments in which to perform networking tests.

### BACKGROUND

Testing the functionality of a network device (e.g., a device under test (DUT)) typically requires connecting the DUT to other network devices (e.g., routers/switches) to form a network in which the test can be performed. The DUT can be tested by generating test traffic in the network and checking whether the DUT processes the test traffic in an expected manner.

Setting up the testing environment for testing the DUT typically requires manually deploying physical network devices in the network and configuring the physical network devices to perform the desired test, which can be prohibitively tedious, expensive, and time consuming. A virtualized testing environment can be used to alleviate some of these drawbacks. A virtualized testing environment includes a set of networked virtual machines (VMs) that can emulate the behavior of a set of networked physical network devices. Deploying and configuring VMs is typically easier, cheaper, and faster than deploying and configuring physical devices. As such, creating virtualized testing environments is generally easier, less expensive, and less time consuming than creating a physical testing environment.

A VM template defines a re-usable VM configuration. A VM template can be used to repeatedly and consistently launch new VMs having a given configuration. VM templates may be useful for creating virtualized testing environments. For example, each test in a suite of test cases can have a corresponding VM template that can be used to create the appropriate virtualized testing environment for that test. A user who wishes to run a specific test can use the VM template corresponding to that test to repeatedly and consistently create the appropriate virtualized testing environment for that test. Typically, the VM template for a test is created manually (e.g., by a user using a graphical user interface (GUI) tool). Each time a new test is added to the test suite, the user needs to manually create a corresponding VM template for that test. Also, each time a test is modified, the user may also need to modify the corresponding VM template for that test in order for the test to run properly. Such manual creation and manual modification of VM templates are time consuming and prone to human errors.

### SUMMARY

A method is implemented by a computing device to automatically generate a virtual machine (VM) template to be used by a test orchestrator for creating a virtualized testing environment in which to perform a networking test. The method includes obtaining a test script from a test script repository, where the test script includes a description of the networking test. The method further includes parsing the test script to determine a set of network devices involved in the networking test and a network connectivity among the set of network devices and generating the VM template based on the set of network devices involved in the networking test and the network connectivity among the set of network devices, where the VM template defines a configuration of networked VMs that virtualizes the set of network devices involved in the networking test and the network connectivity among the set of network devices. The method further includes associating the VM template with the networking test and storing the VM template in a VM template repository, where the VM template in the VM template repository is accessible to the test orchestrator, and where the test orchestrator is to administer creation of the virtualized testing environment based on the VM template and orchestrate performance of the networking test in the virtualized testing environment.

A computing device is configured to automatically generate a virtual machine (VM) template to be used by a test orchestrator for creating a virtualized testing environment in which to perform a networking test. The computing device includes a non-transitory machine-readable storage medium having stored therein a topology parser component and a template generator component. The computing device further includes a set of one or more processors coupled to the non-transitory machine-readable storage medium. The set of one or more processors are configured to execute the topology parser component and the template generator component. The topology parser component is configured to obtain a test script from a test script repository, where the test script includes a description of the networking test. The topology parser component is further configured to parse the test script to determine a set of network devices involved in the networking test and a network connectivity among the set of network devices. The template generator component is configured to generate the VM template based on the set of network devices involved in the networking test and the network connectivity among the set of network devices, where the VM template defines a configuration of networked VMs that virtualizes the set of network devices involved in the networking test and the network connectivity among the set of network devices. The template generator component is further configured to associate the VM template with the networking test and store the VM template in a VM template repository, where the VM template in the VM template repository is accessible to the test orchestrator, and where the test orchestrator is to administer creation of the virtualized testing environment based on the VM template and orchestrate performance of the networking test in the virtualized testing environment.

A non-transitory machine-readable storage medium has computer code stored therein that is to be executed by a set of one or more processors of a computing device. The computer code, when executed by the computing device, causes the computing device to perform operations for automatically generating a virtual machine (VM) template to be used by a test orchestrator for creating a virtualized testing environment in which to perform a networking test. The operations include obtaining a test script from a test script repository, where the test script includes a description of the networking test. The operations further include parsing the test script to determine a set of network devices involved in the networking test and a network connectivity among the set of network devices and generating the VM template based on the set of network devices involved in the networking test and the network connectivity among the set of network devices, where the VM template defines a configuration of networked VMs that virtualizes the set of network devices involved in the networking test and the network connectivity among the set of network devices. The operations further include associating the VM template with the networking test and storing the VM template in a VM template repository, where the VM template in the VM template repository is accessible to the test orchestrator, and where the test orchestrator is to administer creation of the virtualized testing environment based on the VM template and orchestrate performance of the networking test in the virtualized testing environment.

### BRIEF DESCRIPTION OF THE DRAWINGS

The invention may best be understood by referring to the following description and accompanying drawings that are used to illustrate embodiments of the invention. In the drawings:

FIG. 1 is a block diagram of a system that implements automatic virtual machine (VM) template generation, according to some embodiments.

FIG. 2 is a flow diagram illustrating operations of a system that implements automatic VM template generation, according to some embodiments.

FIG. 3 is a flow diagram of a process for automatically generating a VM template, according to some embodiments.

FIG. 4 is a block diagram of a computing device that is configured to implement automatic VM template generation, according to some embodiments.

### DESCRIPTION OF EMBODIMENTS

The following description describes methods and apparatus for automatically generating virtual machine (VM) templates. A test orchestrator can use the VM templates to create a virtualized testing environment in which to perform a networking test. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device (e.g., a computing device) stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

A VM is a software implementation of a physical machine (e.g., a computing device or a network device) that runs applications as if they were executing on a physical, non-virtualized machine; and applications generally do not know they are running on a virtual machine as opposed to running on a “bare metal” host device. Multiple VMs can be implemented on a physical machine (i.e., a host). The VMs running on a host share the underlying hardware resources of the host. A hypervisor (sometimes referred to as a virtual machine monitor (VMM)) manages the allocation of hardware resources among the VMs.

A virtualized testing environment includes a set of networked VMs that can emulate the behavior of a set of networked physical network devices. The VMs can be implemented on a set of hosts (e.g., a set of physical computing/network devices in a data center or cloud environment). The VMs in the virtualized testing environment can be easily deployed and configured to create a desired virtualized testing environment. Virtualized testing environments provide a safe, efficient, and cost-effective way to test a network device by reducing the amount of physical networking equipment that needs to be deployed and configured for testing.

Different types of tests may require different virtualized testing environment configurations (e.g., different topology). Manually creating the virtualized testing environment for a test each time the test is run is inefficient and prone to errors. To avoid such drawbacks, a VM template can be used to create the virtualized testing environment. A VM template for a test defines the VM configurations of the virtualized testing environment for the test. A test orchestrator or similar entity may create the virtualized testing environment for the test based on the VM template for the test. The test orchestrator may then run the test in the virtualized testing environment. VM templates thus provide an efficient way to repeatedly and consistently create virtualized testing environments according to a given configuration. Typically, a VM template for a test is created manually (e.g., by a user using a graphical user interface (GUI) tool). Each time a new test is added to the test suite, the user needs to manually create a corresponding VM template for the test. Also, each time the test is modified, the user may need to manually modify the corresponding VM template for that test in order for the test to run properly. Such manual creation and manual modification of VM templates are time consuming and prone to human errors.

Embodiments herein overcome the disadvantages of the prior art by providing a mechanism for automatically generating a VM template for a test. Embodiments automatically generate a VM template for a test by parsing a test script for network topology information and other information needed for creating a virtualized testing environment in which to perform the test. Automated VM template generation reduces the amount of effort and time required for creating VM templates. Also, automated VM template generation reduces the possibility of human error inherent in manual VM template creation.

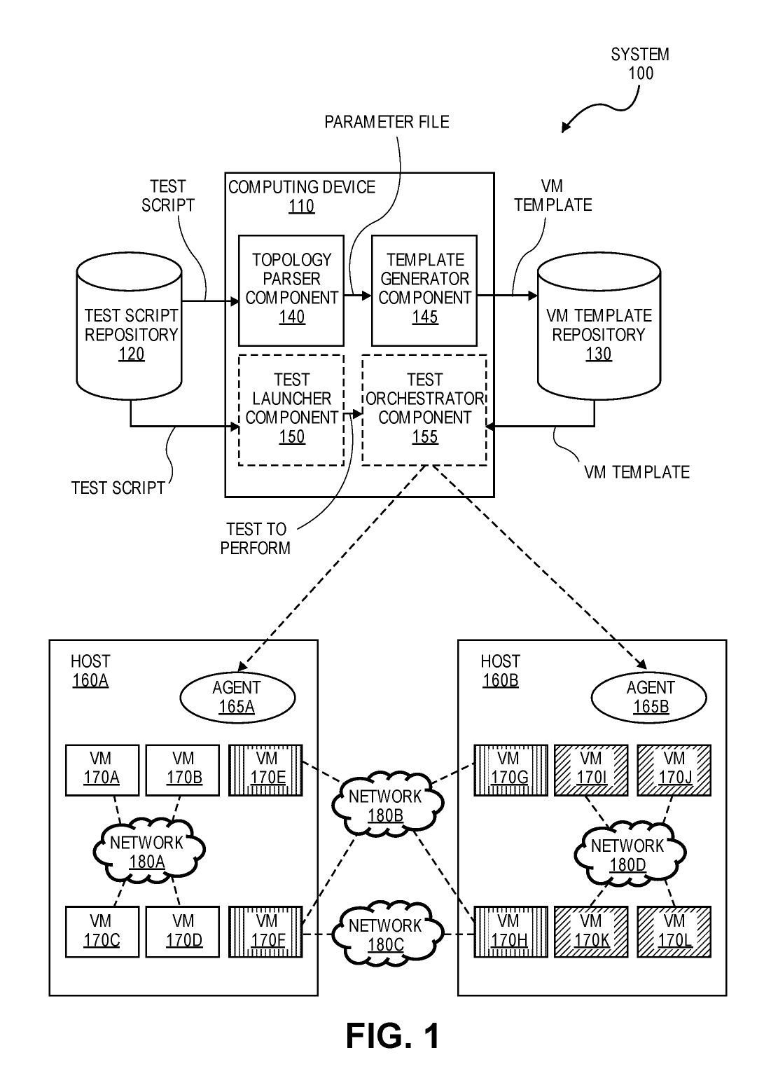

FIG. 1 is a block diagram of a system that implements automatic virtual machine (VM) template generation, according to some embodiments. As illustrated, the system 100 includes a computing device 110, a test script repository 120, a VM template repository 130, and hosts 160A and 160B. The computing device 110 includes a topology parser component 140, a template generator component 145, a test launcher component 150, and a test orchestrator component 155. Although the various components are shown as being implemented by a single computing device 110, in other embodiments, one or more of the components may be implemented by separate computing devices. The test launcher component 150 and the test orchestrator component 155 are shown in dashed lines to indicate that they are optional components of the computing device 110 since they are not strictly required for performing automatic generation of VM templates. These components are shown in order to illustrate how automatically generated VM templates can be used to create virtualized testing environments.

The test script repository 120 stores test scripts. In one embodiment, a test script includes a description of a networking test. For example, a test script may include a set of instructions for performing the networking test, information regarding the set of network devices involved in the networking test, information regarding the network connectivity among the set of network devices involved in the networking test (e.g., network topology), and information regarding the test network traffic that is to be generated by one or more of the network devices in the set of network devices involved in the networking test. Networking tests may include, for example, tests for testing whether a device under test (DUT) conforms to a particular network protocol. A user may create a test script and store it in the test script repository 120. The test script repository 120 can be any type of storage device that is accessible by the computing device 110. Although the test script repository 120 is illustrated as being separate from the computing device 110, in some embodiments, the test script repository 120 is part of the computing device 110.

The topology parser component 140 is able to obtain a test script from the test script repository 120 and parse the test script to determine the set of network devices involved in the networking test described in the test script and the network connectivity among the set of network devices. In one embodiment, the topology parser component 140 can generate a parameter file that includes the various parameter values of the networking test. For example, the parameter file may include information regarding the set of network devices involved in the networking test. This information may include the number of network devices involved in the networking test and the number of ports in each network device. The parameter file may also include information regarding the network connectivity among the set of network devices. This information may include information regarding the connections between the network devices and the Internet Protocol (IP) addresses involved in these connections. The topology parser component 140 can provide the parameter file to the template generator component 145.

The template generator component 145 is able to generate a VM template for the networking test based on the parameter values in the parameter file (e.g., based on the set of network devices involved in the networking test and the network connectivity among the set of network devices). The VM template for the networking test defines a configuration of networked VMs that virtualizes the set of network devices involved in the networking test and the network connectivity among the set of network devices. For example, the VM template may define a configuration where a dedicated VM is created for each network device involved in the networking test to emulate that network device. The VM template may also define a configuration where one or more virtual networks provide connectivity among VMs in a way that emulates the network connectivity among the set of network devices involved in the networking test. The VM template for the networking test thus defines a configuration of a virtualized testing environment in which the networking test can be performed. A virtualized testing environment, as used herein, generally refers to a testing environment in which one or more of the components of the testing environment are virtualized (e.g., using VMs, virtual switches, virtual networks, etc.). The template generator component 145 can store the generated VM template in a VM template repository 130. In one embodiment, the template generator component 145 can also store an association between the VM template and the networking test in the VM template repository 130. This association provides an indication that a virtualized testing environment for performing the networking test can be created using the associated VM template.

The VM template repository 130 stores VM templates. The VM template repository 130 can be any type of storage device that is accessible by the computing device 110. Although the VM template repository 130 is illustrated as being separate from the computing device 110, in some embodiments, the VM template repository 130 is part of the computing device 110. In one embodiment, the test script repository 120 and the VM template repository 130 are implemented by the same storage device (e.g., a database).

The test launcher component 150 is able receive a request to launch a networking test. The request may come, for example, from a user or an automated testing system (e.g., that schedules nightly and weekly regression tests, smoke tests, and functional tests). When the test launcher component 150 receives a request to launch a networking test, the test launcher component 150 can notify the test orchestrator component 155 to orchestrate the performance of the networking test. Upon receiving this notification from the test launcher component 150, the test orchestrator component 155 can obtain the VM template for the requested networking test from the VM template repository 130 and administer creation of a virtualized testing environment in the hosts 160 based on the VM template. A host (e.g., 160A or 160B) can be any type of physical computing/network device that can execute VMs. In one embodiment, the hosts 160 are physical computing/network devices in a data center or a cloud environment. In one embodiment, the test orchestrator component 155 can administer creation of the virtualized testing environment in the hosts 160 by communicating instructions to agents (e.g., 165A and 165B) installed on hosts 160. For example, the test orchestrator component 155 can communicate instructions to the agents 165 to create VMs 170 on their respective hosts 160 and to configure network connectivity among the VMs 170 (e.g., by creating virtual networks) according to the configuration defined in the VM template. This creates the virtualized testing environment in which the networking test can be performed. Once the virtualized testing environment has been created, the test orchestrator component 155 can orchestrate performance of the networking test in the virtualized testing environment according to the test script (e.g., which can be obtained from the test script repository 120). The test orchestrator component 155 can communicate the test status to the test launcher component 150 and the test launcher component 150 can relay the test status to the user.

As illustrated, three virtualized testing environments have been created in the hosts 160. Each virtualized testing environment may have been created using different VM templates. The first virtualized testing environment includes VMs 170A-D, which are connected via network 180A. The second virtualized testing environment includes VMs E-H, which are connected via network 180B and network 180C. The third virtualized testing environment includes VMs 170I-L, which are connected via network 180D. A separate networking test can be performed within each virtualized testing environment. For purposes of simplicity and clarity, the virtualized testing environments are shown as being implemented by two hosts 160. However, it should be understood that the virtualized testing environments can be implemented by any number of hosts 160. Furthermore, it should be understood that each host 160 can host any number of VMs.

In one embodiment, each time a new test script is added to the test script repository 120, the computing device 110 may automatically generate VM templates for the networking tests described in the test script and store the VM templates in the VM template repository 130. Also, each time an existing test script in the test script repository 120 is updated, the computing device 110 may automatically update the associated VM template for any networking tests that have been updated in that test script. Automatic VM template generation avoids the need for users to manually create/update VM templates each time a new test script is added or a test script is updated. A further advantage of automatic VM template generation is that it is faster and less error-prone than manual VM template creation.

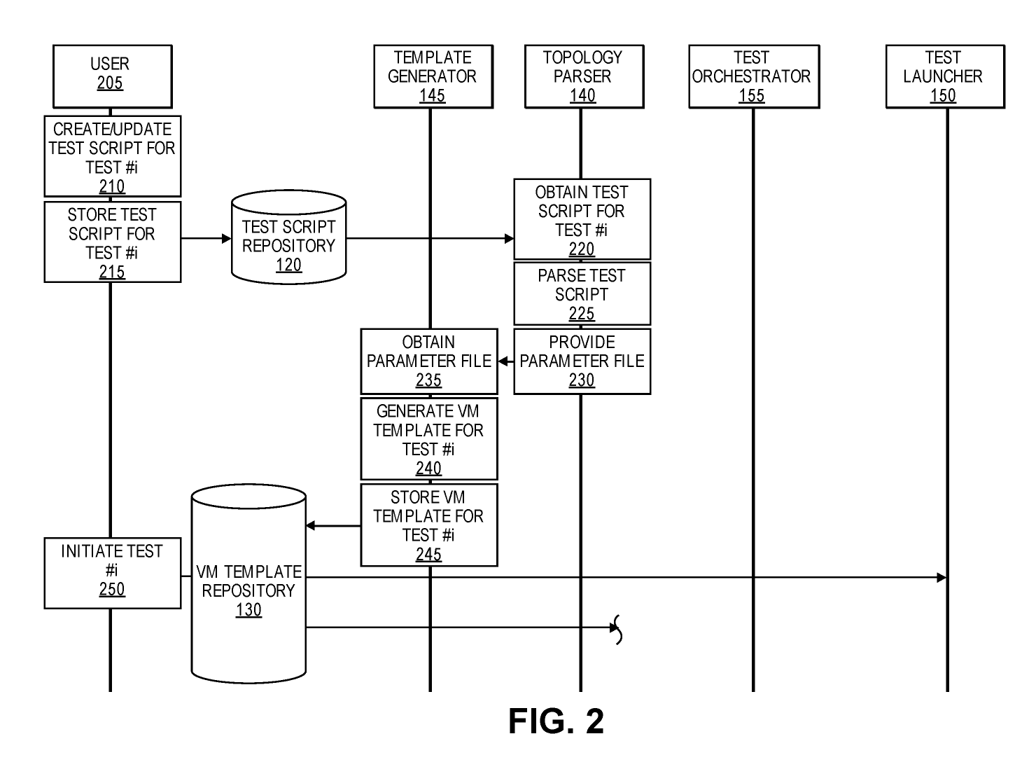

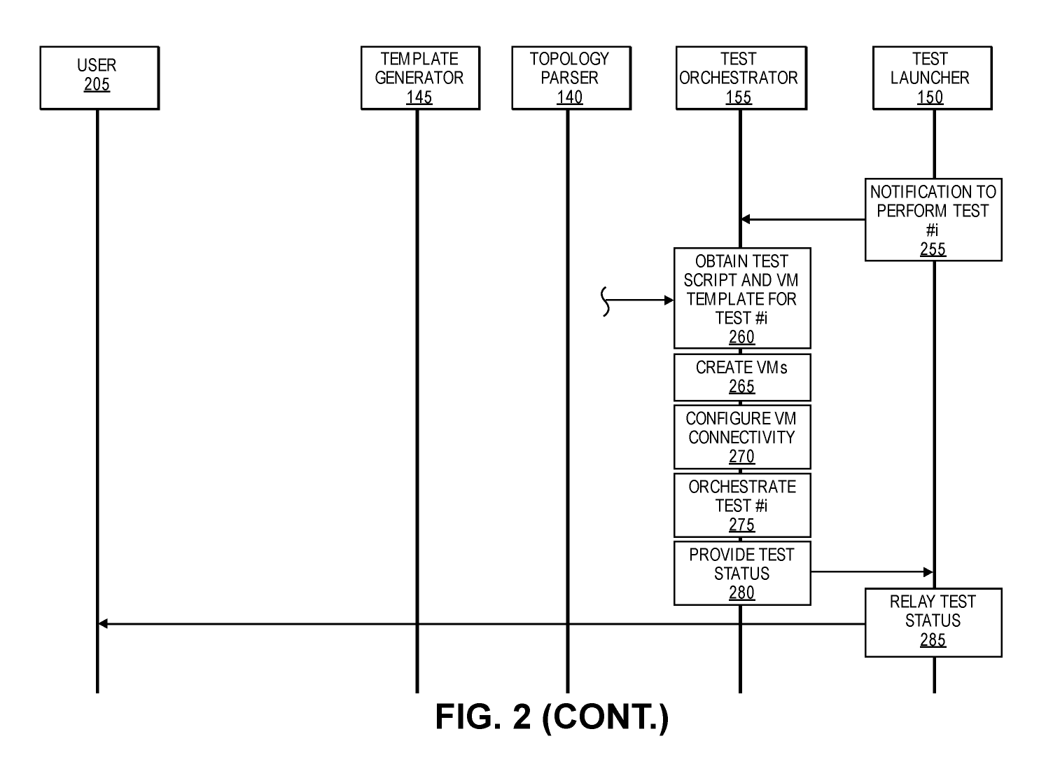

FIG. 2 is a flow diagram illustrating operations of a system that implements automatic VM template generation, according to some embodiments. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

A user 205 creates or updates a test script for a test (e.g., test #i) (block 210). The user 205 stores the test script for test #i in the test script repository 120 (block 215). The topology parser component 140 obtains the test script for test #i from the test script repository 120 (block 220) and parses the test script to determine the set of network devices involved in the networking test and the network connectivity among the set of network devices (block 225). The topology parser component 140 may store this information in the form of a parameter file. The topology parser component 140 then provides the parameter file to the template generator component 145 (block 230). The template generator component 145 obtains the parameter file (block 235) and generates a VM template for test #i based on the parameter file (block 240). The template generator component 145 stores the VM template for test #i in the VM template repository 130 (block 245).

Subsequently, the user 205 initiates test #i (block 250), for example, by making a request to the test launcher component 150 to launch test #i. The test launcher component 150 then notifies the test orchestrator component 155 to perform test #i (block 255). In response, the test orchestrator component 155 obtains the test script for test #i from the test script repository 120 and obtains the VM template for test #i from the VM template repository 130 (block 260). The test orchestrator component 155 then creates VMs 170 in the hosts 160 (block 265) and configures network connectivity among the VMs 170 (block 270) according to the VM template (e.g., by communicating instructions to agents 165 installed in the hosts 160). This creates a virtualized testing environment for performing the networking test described in the test script. The test orchestrator component 155 orchestrates performance of the networking test in the virtualized testing environment according to the test script (block 275) and provides the test status to the test launcher component 150 (block 280). The test launcher component 150 then relays the test status to the user 205 (block 285).

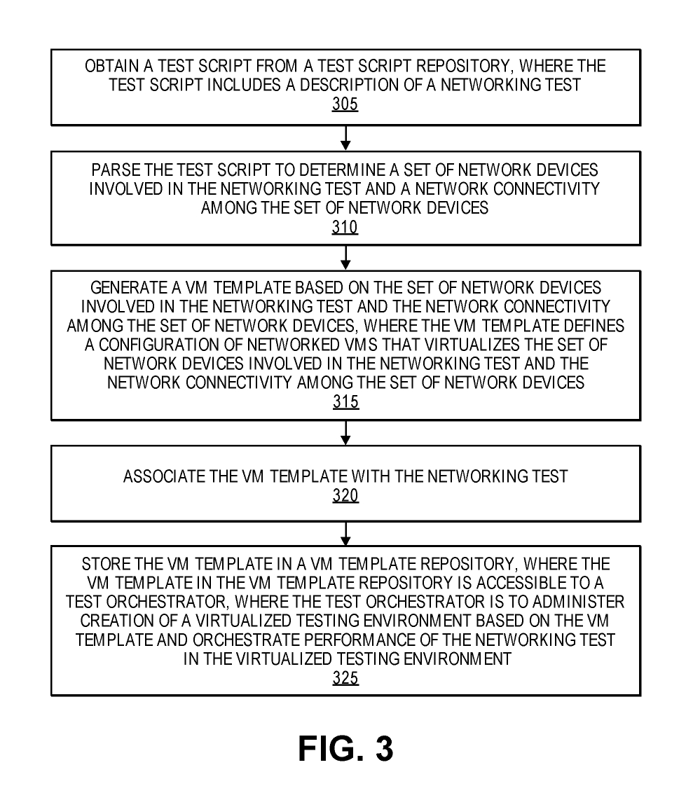

FIG. 3 is a flow diagram of a process for automatically generating a VM template, according to some embodiments. The process automatically generates a VM template to be used for creating a virtualized testing environment in which to perform a networking test. In one embodiment, the operations of the flow diagram may be performed by various components of a computing device 110 (e.g., topology parser component 140 and template generator component 145).

The topology parser component 140 obtains a test script from a test script repository 120 (block 305). The test script includes a description of a networking test. For example, the test script may include a set of instructions for performing the networking test. In one embodiment, the test script also includes information regarding the set of network devices involved in the networking test, the network connectivity among the set of network devices involved in the networking test, and the test network traffic that is to be generated by one or more of the network devices in the set of network devices involved in the networking test.

The topology parser component 140 parses the test script to determine a set of network devices involved in the networking test and a network connectivity among the set of network devices (block 310). The topology parser component 140 may parse the test script using any suitable parsing algorithm. For example, the topology parser component 140 may apply lexical analysis, syntax analysis, and/or semantic analysis on the test script to determine the set of network devices involved in the networking test described in the test script and the network connectivity among the set of network devices. This information may include the number and types of network devices involved in the networking test, the number and types of ports in each network device, the number and types of connections among the network devices, how these network devices, ports, and connections are being used and connected in relation to generated traffic patterns, or any combination thereof. The topology parser component 140 may utilize different parsing algorithms for different test scripts depending on test script format (e.g., test scripts written using different scripting languages or test scripts having different layout/structure). In one embodiment, the topology parser component 140 stores information regarding the set of network devices involved in the networking test and the network connectivity among the set of network devices in a parameter file (as a list of parameter values). The topology parser component 140 may then provide the parameter file to a template generator component 145.

The template generator component 145 generates the VM template based on the set of network devices involved in the networking test and the network connectivity among the set of network devices (e.g., as specified in the parameter file) (block 315). The generated VM template defines a configuration of networked VMs that virtualizes the set of network devices involved in the networking test and the network connectivity among the set of network devices. The VM template thus defines a configuration of a virtualized testing environment in which the networking test can be performed. The template generator component 145 may obtain information regarding the network devices involved in the networking test and the network connectivity among the set of network devices from the topology parser component 140 (e.g., in the form of a parameter file) and use this information to generate the VM template. For example, generating the VM template may involve defining a set of VMs specified in the VM template that represent the set of network devices involved in the networking test and defining virtual networks (connecting the VMs) specified in the VM template that represent the connectivity among the network devices. The template generator component 145 may generate VM templates in any suitable format (e.g., in a format understood by the test orchestrator component 155, which could be specific to a particular VM software vendor). In one embodiment, the VM template includes network connectivity information for one or more VMs 170. In one embodiment, the VM template includes information regarding an amount of computing resources (e.g., central processing unit (CPU) resources, memory, storage, etc.) to provision for one or more VMs 170. In one embodiment, the VM template includes information regarding an image that is to be installed on one or more VMs 170.

The template generator component 145 associates the VM template with the networking test (block 320) and stores the VM template in a VM template repository 130 (block 325). The VM template stored in the VM template repository 130 is accessible to a test orchestrator (e.g., test orchestrator component 155) such that the test orchestrator can obtain the VM template from the VM template repository 130 and administer the creation of a virtualized testing environment (e.g., in one or more hosts 160) based on the VM template. The test orchestrator may then orchestrate performance of the networking test in the virtualized testing environment. In one embodiment, the template generator component 145 stores an association between the VM template and the networking test in the VM template repository 130. This allows the test orchestrator to easily identify the appropriate VM template to use for a given networking test.

In this way, the process automatically generates a VM template for a networking test. In one embodiment, the process can be triggered when the computing device 110 detects that a new test script has been added to the test script repository 120 in order to automatically generate VM templates for the networking tests described in the newly added test script. In one embodiment, a similar process as the process described above can be triggered when the computing device 110 detects that an existing test script in the test script repository 120 has been updated in order to automatically update the VM template (in case any networking tests described in the test script have changed and require a different virtualized testing environment).

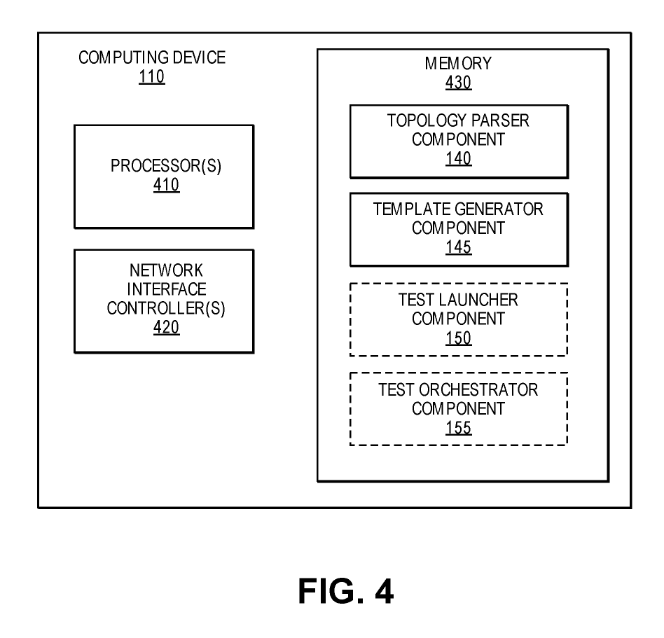

FIG. 4 is a block diagram of a computing device that is configured to implement automatic VM template generation, according to some embodiments. The computing device 110 can perform some or all of the operations and methods described above for one or more embodiments. It should be noted that the computing device 110 is provided by way of example rather than limitation, and that other computing devices with differing configurations can implement some or all of the operations and methods described above for one or more of the embodiments. In the exemplary embodiment, the computing device 110 includes one or more processor(s) 410, one or more network interface controller(s) 420 (NIC(s); also known as network interface card(s)), and memory 430. The memory 430 has stored therein a topology parser component 140 and a template generator component 145. Optionally, the memory 430 also has stored therein a test launcher component 150 and a test orchestrator component 155.

The processor(s) 410 may include one or more data processing circuits, such as a general purpose and/or special purpose processor (e.g., microprocessor and/or digital signal processor). The processor(s) 410 is coupled to the memory 430 and is operable to execute the various components stored in the memory (e.g., topology parser component 140, template generator component 145, optional test launcher component 150, and optional test orchestrator component 155) to perform some or all of the operations and methods described above for one or more of the embodiments, such as the embodiments of FIG. 3.

The memory 430 can be read-only memory (ROM), flash memory, dynamic random access memory (DRAM), magnetic disks, optical disks, phase change memory, or any type of non-transitory machine-readable media that is capable of storing code for execution on the processor(s) and/or capable of storing data.

The NIC(s) 420 (which include physical network interface(s)) are capable of establishing network connections (to transmit and/or receive code and/or data using propagating signals) with other computing devices such as hosts 160 in a data center or a cloud over a wired or wireless network.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

An embodiment of the invention may be an article of manufacture in which a non-transitory machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method implemented by a computing device to automatically generate a virtual machine (VM) template to be used by a test orchestrator for creating a virtualized testing environment in which to perform a networking test, the method comprising:
obtaining a test script from a test script repository, wherein the test script includes a description of the networking test;
parsing the test script to determine a set of network devices involved in the networking test and a network connectivity among the set of network devices;
generating the VM template based on the set of network devices involved in the networking test and the network connectivity among the set of network devices, wherein the VM template defines a configuration of networked VMs that virtualizes the set of network devices involved in the networking test and the network connectivity among the set of network devices;
associating the VM template with the networking test; and
storing the VM template in a VM template repository, wherein the VM template in the VM template repository is accessible to the test orchestrator, wherein the test orchestrator is to administer creation of the virtualized testing environment based on the VM template and orchestrate performance of the networking test in the virtualized testing environment.

2. The method of claim 1, wherein the test script includes information regarding the set of network devices involved in the networking test, the network connectivity among the set of network devices involved in the networking test, and test network traffic that is to be generated by one or more of the network devices in the set of network devices involved in the networking test.

3. The method of claim 1, wherein the VM template includes network connectivity information for one or more of the VMs.

4. The method of claim 1, wherein the VM template includes information regarding an amount of computing resources to provision for one or more of the VMs.

5. The method of claim 1, wherein the VM template includes information regarding an image that is to be installed on one or more of the VMs.

6. The method of claim 1, further comprising:
storing an association between the VM template and the networking test in the VM template repository.

7. The method of claim 1, further comprising:
automatically updating the VM template stored in the VM template repository upon determining that the test script has been updated in the test script repository.

8. A computing device configured to automatically generate a virtual machine (VM) template to be used by a test orchestrator for creating a virtualized testing environment in which to perform a networking test, the computing device comprising:
a non-transitory machine-readable storage medium having stored therein a topology parser component and a template generator component; and
a set of one or more processors coupled to the non-transitory machine-readable storage medium, the set of one or more processors configured to execute the topology parser component and the template generator component, the topology parser component configured to obtain a test script from a test script repository, wherein the test script includes a description of the networking test, the topology parser component further configured to parse the test script to determine a set of network devices involved in the networking test and a network connectivity among the set of network devices, the template generator component configured to generate the VM template based on the set of network devices involved in the networking test and the network connectivity among the set of network devices, wherein the VM template defines a configuration of networked VMs that virtualizes the set of network devices involved in the networking test and the network connectivity among the set of network devices, the template generator component further configured to associate the VM template with the networking test, and store the VM template in a VM template repository, wherein the VM template in the VM template repository is accessible to the test orchestrator, wherein the test orchestrator is to administer creation of the virtualized testing environment based on the VM template and orchestrate performance of the networking test in the virtualized testing environment.

9. The computing device of claim 8, wherein the test script includes information regarding the set of network devices involved in the networking test, the network connectivity among the set of network devices involved in the networking test, and test network traffic that is to be generated by one or more of the network devices in the set of network devices involved in the networking test.

10. The computing device of claim 8, wherein the VM template includes network connectivity information for one or more of the VMs.

11. The computing device of claim 8, wherein the VM template includes information regarding an amount of computing resources to provision for one or more of the VMs.

12. The computing device of claim 8, wherein the VM template includes information regarding an image that is to be installed on one or more of the VMs.

13. The computing device of claim 8, wherein the template generator component is further configured to store an association between the VM template and the networking test in the VM template repository.

14. The computing device of claim 8, wherein the template generator component is further configured to automatically update the VM template stored in the VM template repository upon determining that the test script has been updated in the test script repository.

15. A non-transitory machine-readable storage medium having computer code stored therein, which when executed by a set of one or more processors of a computing device, causes the computing device to perform operations for automatically generating a virtual machine (VM) template to be used by a test orchestrator for creating a virtualized testing environment in which to perform a networking test, the operations comprising:
obtaining a test script from a test script repository, wherein the test script includes a description of the networking test;
parsing the test script to determine a set of network devices involved in the networking test and a network connectivity among the set of network devices;
generating the VM template based on the set of network devices involved in the networking test and the network connectivity among the set of network devices, wherein the VM template defines a configuration of networked VMs that virtualizes the set of network devices involved in the networking test and the network connectivity among the set of network devices;
associating the VM template with the networking test; and
storing the VM template in a VM template repository, wherein the VM template in the VM template repository is accessible to the test orchestrator, wherein the test orchestrator is to administer creation of the virtualized testing environment based on the VM template and orchestrate performance of the networking test in the virtualized testing environment.

16. The non-transitory machine-readable storage medium of claim 15, wherein the test script includes information regarding the set of network devices involved in the networking test, the network connectivity among the set of network devices involved in the networking test, and test network traffic that is to be generated by one or more of the network devices in the set of network devices involved in the networking test.

17. The non-transitory machine-readable storage medium of claim 15, wherein the VM template includes network connectivity information for one or more of the VMs.

18. The non-transitory machine-readable storage medium of claim 15, wherein the VM template includes information regarding an amount of computing resources to provision for one or more of the VMs.

19. The non-transitory machine-readable storage medium of claim 15, wherein the VM template includes information regarding an image that is to be installed on one or more of the VMs.

20. The non-transitory machine-readable storage medium of claim 15, wherein the computer code, when executed by the set of one or more processors of the computing device, causes the computing device to perform further operations comprising:
storing an association between the VM template and the networking test in the VM template repository.

21. The non-transitory machine-readable storage medium of claim 15, wherein the computer code, when executed by the set of one or more processors of the computing device, causes the computing device to perform further operations comprising:
automatically updating the VM template stored in the VM template repository upon determining that the test script has been updated in the test script repository.
